(19) United States
(12) Patent Application Publication
(10) Pub. No.: US 2025/0211457 A1
(43) Pub. Date: Jun. 26, 2025

(54) TELEPRESENCE WITH A HUMAN AVATAR

(71) Applicant: Faceport Inc., New York, NY (US)

(72) Inventor: Evan John Kaye, New York, NY (US)

(21) Appl. No.: 19/001,101

(22) Filed: Dec. 24, 2024

Related U.S. Application Data
(60) Provisional application No. 63/614,598, filed on Dec. 24, 2023.
(60) Provisional application No. 63/704,909, filed on Oct. 8, 2024.

(51) Int. Cl. H04L 12/18; G06F 3/16; G06T 13/40; G06T 17/00; G09G 3/32; G09G 3/3208; H04N 7/18; H04N 9/31; H04N 13/302

(52) U.S. Cl. CPC H04L 12/1813; G06F 3/167; G06T 13/40; G06T 17/00; H04N 7/18; H04N 9/3179; H04N 13/302; G09G 3/32; G09G 3/3208

(57) ABSTRACT

A system for providing telepresence of a remote user on a human avatar is provided. The system includes a head-mounted unit worn by a human avatar with an attached electronic device used for videoconferencing between a local user in close proximity to the human avatar and a remote user in a different location. The remote user uses their own electronic device to send and receive the live audio-video feed of the videoconference to and from the first electronic device via the Internet or cellular network. The human avatar may use an additional electronic device to control the electronic device attached to the head-mounted unit and communicate discreetly with the remote user to receive their instructions. A software application helps remote users and human avatars connect with each other through a marketplace service, and enables a number of features on the electronic devices during the telepresence experience.

### CROSS-REFERENCE TO RELATED APPLICATIONS

This application claims priority to U.S. Provisional Patent Ser. No. 63/614,598, filed Dec. 24, 2023, and U.S. Provisional Patent Ser. No. 63/704,909, filed October 8 2024, which are hereby incorporated in their entirety at least by reference.

### BACKGROUND OF THE INVENTION

1. Field of the Invention

The present invention relates to videoconferencing technology but more particularly a system for providing telepresence on a human avatar.

2. Description of Related Art

It has become increasingly common to video conference with others for social interactions or in business interactions. There are many situations where the current format of videoconferencing is not optimal because a person may wish to immerse themselves in a remote environment and interact with people there in a manner that more closely approximates them being there. These include, for example: (1) attending an important business meeting or networking event; (2) walking the expo hall of a trade show; (3) visiting a store; (4) attending a wedding, family event or cocktail party; or (5) in the case of a medical professional, participating in hospital rounds and interacting with in-patients. In many of these and other cases, people expend tremendous effort and expense to physically travel to such places, sometimes around the world, and oftentimes when it is not feasible or desirable. The aforementioned examples involve brief interactions with many people where in-person interactions typically involve shaking someone's hand and having a few minute conversation, oftentimes unplanned. Existing video conference systems are not conducive to such interactions.

Some companies have opted to solve this challenge by creating remotely-controlled robotic avatars that contain a tablet computer enabling one to achieve a virtual presence at a location. A variety of these devices are available for sale online, for example by TelepresenceRobots.com. This global telepresence market is estimated to be worth $334 million in 2023, and grow to $1.6 billion over the next 10 years driven substantially by adoption in the healthcare field according to the research company Fact.MR. However, there are many shortcomings of existing robotic avatars including: (1) they are no match for the agility of humans and their ability to navigate around obstacles like furniture, stairs or other people; (2) they require charging; (3) they move slowly and need to be guided by the remote operator or someone locally; (4) they can be noisy and disruptive; (5) they are expensive ranging in price from $1,200 to $80,000; (6) they are at a significant disadvantage to humans in moving around outdoor environments; and (7) they do not blend in seamlessly in a business or social setting.

The conventional interaction with robotic avatars is described here. A remote user interacts with an electronic device equipped with a display, microphone, speaker and Internet connectivity. A robotic avatar communicates with the remote user's device via the Internet, and similarly has a display, microphone, speaker and Internet connectivity. The robotic avatar additionally has a means of movement, typically motorized with wheels that are controlled by the remote user. A local user communicates with the remote user via videoconference on the robotic avatar.

A remote user or participant is a person who is not physically present in the local environment but is experiencing it through telepresence technology. They are usually in a different location and connected via telecommunication devices like cameras, microphones, and screens or more advanced systems like virtual reality (VR) headsets, or robotic avatars in the case of telepresence in a physical environment.

A local user or participant is a person who is physically present in the environment where the telepresence is taking place. They interact with the remote participant through the telepresence system. In some cases the local user may also refer to a person or entity (like a robot or a sensor) that acts as another remote user's proxy or representative in that environment.

Shared robotic avatars have been used at industry conferences, where remote attendees can take turns utilizing a robotic avatar, as documented in the journal article by Neustaedter et al. Currently, there is no central platform that exists for a user to find a robotic avatar and make use of it at its current location, or at a location of the user's choosing.

Various other prior art exists in this domain and are briefly described here. The YouTube© video “iPad Head Girl” is a promotional video where a person's head was pre-recorded from multiple angles and then displayed on a head-mounted cube with tablet computers attached on four sides. There is no video-conferencing interaction shown between a local user and a remote user. Faufal manufactures a head strap mount used for action photography, which is one of many such mounts for mobile devices. While the phone can be flipped around and mounted on the head with the screen facing forward, it is clearly not optimized to be a head-mounted tablet computer device approximating a remote user's head on a human avatar's body. The Apple® Vision Pro virtual reality (VR) headset can create a “persona” of the wearer of the headset, this reconstructed animated image can be used in a VR context or shared in a video chat setting.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

What is needed in the art and has heretofore not been described is a system comprising hardware and software which facilitates the telepresence of a first person's face on a second person's body. This is achieved by swapping out the robotic avatar with a human avatar where the human avatar has a head-mounted device equipped with videoconferencing capabilities (display, microphone, speaker and a communications device). This allows for virtual presence, where the face of the remote user is shown on a display, creating an illusion of their physical presence, and a camera on the device is used to capture the surroundings and relay them back to the remote user. Speakers and microphones are used on both sides in a conventional way to enable videoconferencing.

It is a particular object of the invention to provide telepresence through the use of a human avatar.

In order to do this, in one aspect of the invention, a system is provided, enabling the telepresence of a remote user on a human avatar, comprising a head-mounted unit configured to be worn by the human avatar; a first electronic device equipped with at least one display, at least one microphone, at least one speaker, at least one camera, and hardware configured to enable the first electronic device to connect to the Internet, wherein the first electronic device is attached to, removably attached to, or integrated into, the head-mounted unit and is configured to be positioned in front of the human avatar's face; a second electronic device configured to be operated by the remote user, wherein the second electronic device comprises a display, a microphone, a speaker, a processor, memory, a data storage, and hardware configured to enable the first electronic device to connect to the Internet; a software application executed on the first electronic device and the second electronic device, wherein the software application is configured to enable the second electronic device to transmit data containing a live video-audio feed, via the Internet (with or without the use of a cellular network), to the first electronic device and vice-versa. The software application may be a special purpose application, or a web browser.

In one embodiment, a third electronic device operated by the human avatar is provided, wherein the third electronic device comprises a display, a microphone, a speaker, a processor, memory, a data storage, hardware configured to enable the third electronic device to connect to the Internet (with or without the use of a cellular network), and hardware configured to enable the third electronic device to communicate with the first electronic device via short range wireless communication; and, wherein the software application is executed on the third electronic device enabling the human avatar to control the first electronic device, and transmit data, via the Internet or the cellular network, between the second electronic device used by the remote user, and the third electronic device used by the human avatar, enabling the human avatar and the remote user to communicate with each other by audio or text. The first device on or in the helmet may connect to the Internet via the third device (such as a Wifi hotspot exposed by the third device), or directly to the Internet. The third device may be used to control the first device through messages at a central server, and need not communicate necessarily through a short range wireless communication.

In one embodiment, the software application executed on the second electronic device configured to be used by the remote user includes a “whisper” element enabling the remote user to speak into the microphone to transmit a first audio message to only the third electronic device, wherein the human avatar is configured to receive the first audio message through earphones worn by the human avatar; and, wherein the software application executed on the third electronic device configured to be operated by the human avatar also includes a “whisper” element enabling the human avatar to speak into the microphone of the third electronic device to transmit a second audio message to the second electronic device operated by the remote user and played back to the remote user through speakers or headphones worn by the remote user or displayed as text on the display.

In one embodiment, the software application executed on the second electronic device configured to be used by the remote user includes a “whisper” element enabling the remote user to send a first text message, by speaking into the microphone or typing, to only the third electronic device, wherein the human avatar is configured to receive the first text message on the third electronic device; and, wherein the software application executed on the third electronic device configured to be operated by the human avatar also includes a “whisper” element enabling the human avatar to send a second text message, by speaking into the microphone or typing, back to the second electronic device operated by the remote user and played back to the remote user through speakers or headphones worn by the remote user or displayed as text on the display.

In one embodiment, the first electronic device attached to the head-mounted unit and the third electronic device configured to be used by the human avatar are logically paired to communicate with each other by the third electronic device scanning a QR code on the first electronic device or by the human avatar signing into each device with their specific system user credentials.

In one embodiment, the head-mounted unit is a vehicle helmet which protects the human avatar during transit, and the first electronic device attached to the head-mounted unit is connected to a swivel mechanism mounted on both sides of the head-mounted unit, enabling the first electronic device to move between a first position in front of the human avatar's face and a second position above the human avatar's head.

In one embodiment, a portion of the head-mounted unit is made of a darkly-tinted, two-way transparent mirrored material through which the human avatar can see and the local user cannot.

In one embodiment, the first electronic device attached to the head-mounted unit displays video of the remote user and video of the local user simultaneously on the at least one display.

In one embodiment, the at least one display of the first electronic device is a curved screen.

In one embodiment, there is at least one camera on the head-mounted unit or first electronic device, that transmits data in the form of video to personal video viewing glasses worn by the human avatar to enable the human avatar to have pass-through vision to view their surroundings.

In one embodiment, the at least one display of the first electronic device is attached to a bottom portion of a front visor on the head-mounted unit and oriented to face downwards, and the video image on the at least one display reflects off of a two-way mirror attached to the head-mounted unit and extending downwards in front of the human avatar's face and oriented at an angle to reflect the video image into an eyeline of the local user.

In one embodiment, the first electronic device attached to the head-mounted unit has two displays, a first display above and a second display below a horizontally-oriented two-way mirror strip through which the human avatar can see in front of themselves without their eyes being seen by the local user.

In one embodiment, the at least one display of the first electronic device is a plurality of displays, with each display positioned on a different location on the head-mounted unit, and the second electronic device configured to be used by the remote user is configured to produce a 3D face model of the remote user and transmit data containing the 3D face model to the first electronic device, and the software application executed on the first electronic device is configured to use the 3D face model to display portions of the remote user's face on the plurality of displays of the first electronic device to provide a realistic 3D video image of the remote user's face to the local user.

In one embodiment, the at least one display of the first electronic device is a shape with a rear-projection film applied, wherein the at least one display is attached to the head-mounted unit and positioned in front of the human avatar's face, and the second electronic device configured to create a 3D face model of the remote user and transmit data containing the 3D face model to the first electronic device, and the first electronic device configured to transmit data to a short-throw projector positioned inside the head-mounted unit, and the short-throw projector configured to transmit light to the at least one display to display a video image of the remote user on the at least one display for viewing by the local user, and the first electronic device configured to use the 3D face model to make adjustments of the video image based on the shape of the at least one display to provide an accurate appearance of the remote user's face to the local user, and wherein the at least one display is tinted such that the local user is not able to see the face of the human avatar.

In one embodiment, one or more cameras are mounted on the head-mounted unit or the first electronic device and are configured to monitor and transmit the position of the local user's eyes to the first electronic device, wherein the first electronic device using the 3D face model renders an accurate video image of the remote user's face at a vantage point of the local user and produces the video image on the at least one display using the short-throw projector to create the video image on the the at least one display with the rear-projection film applied.

In one embodiment, the 3D face model is an alternate 3D face model of a face different than that of the remote user, including another human face or a cartoon face.

In one embodiment, the 3D face model is stored locally on the memory of the first electronic device and vector coordinates of facial movements of the remote user are captured by the second electronic device and transmitted to the first electronic device and are used by the first electronic device with the locally stored 3D face model to modify the video image of the remote user to be displayed to the local user.

The foregoing has outlined rather broadly the more pertinent and important features of the present disclosure so that the detailed description of the invention that follows may be better understood and so that the present contribution to the art can be more fully appreciated. Additional features of the invention, which will be described hereinafter, form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a diagram of the telepresence system using a human avatar according to an embodiment of the present invention.

FIG. 2 is a perspective view of a telepresence interaction between a local user and a remote user in a medical application according to an embodiment of the present invention.

FIG. 3A is a side view of a head-mounted unit as an open-faced motorcycle helmet according to an embodiment of the present invention.

FIG. 3B is a side view of a human avatar wearing an obstructed view helmet with pass-through vision according to an embodiment of the present invention.

FIG. 3C is a side view of a human avatar wearing a reflection screen helmet according to an embodiment of the present invention.

FIG. 3D is a front-side perspective view of a human avatar wearing a composite facial display helmet according to an embodiment of the present invention.

FIG. 3E is a perspective view of a telepresence interaction where the head-mounted unit is a rear projection helmet according to an embodiment of the present invention.

FIG. 3F is a perspective view of the head-mounted unit as a front-side display helmet according to an embodiment of the present invention.

FIG. 3G is a side view of a human avatar wearing an obstructed view helmet with a removable display and a rear counterweight according to an embodiment of the present invention.

FIG. 3H is a side view of a human avatar wearing a helmet with an integrated transparent OLED screen according to an embodiment of the present invention.

FIG. 3I is a side view of a human avatar wearing an obstructed view helmet with a removable display with an integrated rear-facing display, and a rear counterweight according to an embodiment of the present invention.

FIG. 4A is a network diagram of a telepresence marketplace service according to an embodiment of the present invention.

FIG. 4B is a view of a map view screen of a telepresence marketplace service mobile application according to an embodiment of the present invention.

FIG. 4C is a view of an active teleconference screen of a telepresence marketplace service mobile application according to an embodiment of the present invention.

FIG. 5 is a network diagram showing an interaction between first, second and third electronic devices of the system according to an embodiment of the present invention.

FIG. 6. is a view of a robotic upper body that has a head-mounted unit docked on its head according to an embodiment of the present invention.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide telepresence with a human avatar.

It is to be understood that the terminology used herein is for the purpose of describing particular embodiments only and is not intended to be limiting. The terms “a” or “an,” as used herein, are defined as to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure.

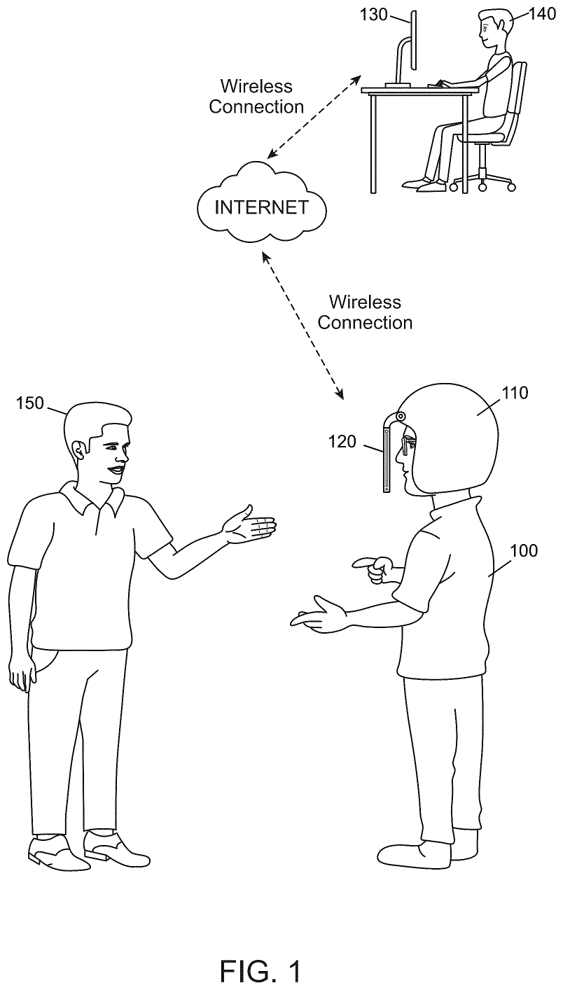

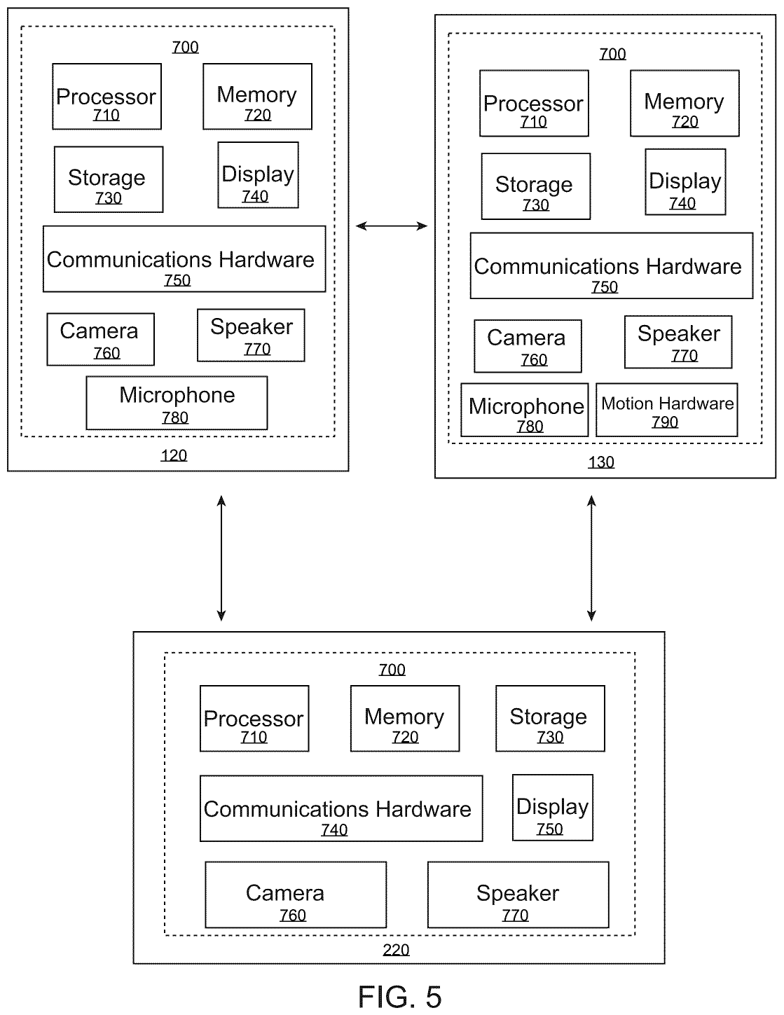

The participants, hardware and applications in the invention can be appreciated in FIG. 1. In one embodiment, a human avatar 100 wears a head-mounted unit (or helmet) 110 with an attached first electronic device 120 which may be a tablet computer, mobile phone or another type of device, and as seen in FIG. 5 is equipped with at least one display 740, at least one camera 760, at least one microphone 780, at least one speaker 770, a processor 710, memory 720, data storage 730 and at least one means of communication to the Internet 750 which may include WiFi, cellular, satellite, or other known technologies. The first electronic device 120 is connected, via the Internet, to a second electronic device 130 which may be a tablet computer, mobile phone, personal computer or another type of device, and as seen in FIG. 5 is equipped with at least one display 740, at least one camera 760, at least one microphone 780, at least one speaker 770, a processor 710, memory 720, data storage 730 and at least one means of communication to the Internet 750 which may include WiFi, cellular, satellite, or other known technologies. In one embodiment, the second electronic device 130 is used by a remote user 140 in a different location than the human avatar 100. Advantageously, the human avatar 100 can walk freely and does not require wheels like the robotic avatar. A local user 150 communicates with the remote user 140 via videoconference on the first electronic device 120 attached to the head-mounted unit 110 worn by the human avatar 120.

In another embodiment, shown in FIG. 5, the first electronic device 120 attached to the head-mounted unit 110 does not use a connection to the Internet. In this embodiment, the human avatar 100 has a third electronic device 220, which may be a mobile phone, tablet computer or another device, equipped with at least one display 740, at least one camera 760, at least one microphone 780, at least one speaker 770, a processor 710, memory 720, data storage 730 and at least one means of communication to the Internet 750 which may include WiFi, cellular, satellite, or other known technologies, and which connects wirelessly to the first electronic device 120 via Bluetooth© or a WiFi hotspot from the third device, and the second electronic device 130 via Internet or cellular network. The third electronic device relays data between the first electronic device 120 and the second electronic device 130. An advantage of this embodiment is that if the signal used for connectivity to the Internet is cellular, then the cellular radiation would be coming from the third electronic device and not the first electronic device which is mounted on the head of the human avatar 100. It is typically preferable to reduce the amount of cellular radiation in close proximity to the head.

In another embodiment, the first electronic device 120 and the third electronic device 220 are running a software application to manage the local Bluetooth® connection between the two devices. The application on the third electronic device allows the human avatar 100 to control the first electronic device 120 and to communicate directly via text or audio with the remote user 140 who is running the software application on the second electronic device 130. The conversation between the human avatar 100 using the third electronic device 220 and the remote user 140 using the second electronic device 130 is referred to as “whispering”. If communicating via text, the human avatar 100 may be alerted to a new message through vibration or audio signal, and then type a response to the remote user 140. If communicating via audio, the remote user 140 would hold down a “whisper” button on the second electronic device 130 for the duration of their speaking, that would allow them to speak only to the human avatar 100 by sending audio only to the third electronic device 220. Whether the whisper is to a third device, or to the first device, the audio may be emitted from the speaker of that device, or to the human avatar via wired or wireless earpieces. In one embodiment, the speaker system playing audio to the human avatar 100 may be built into the helmet 110. In another embodiment, the human avatar 100 is wearing earphones equipped with a microphone and connected by a wired or wireless connection to the third electronic device 220 which allows them to hear the audio message discreetly from the remote user 140 and to respond with their own audio message using the “whisper” button on the third electronic device 220 in the same way as just described for the remote user 140. In another embodiment, the software application has a soundboard with frequently used commands that the human avatar 100 and remote user 140 can use to quickly communicate with each other via text or audio.

In another embodiment, the software application will translate the text or audio communication between the remote user 140 and the human avatar 100 on-the-fly if they are communicating in different languages.

In another embodiment, both the first electronic device 120 and the third electronic device 220 are connected to the Internet but do not need to have a direct communication link between them. In this embodiment, a logical connection is made between the two devices by, for example, having the third electronic device 220 scan a QR code on the display of the first electronic device 120, to inform the software application that the two devices are logically paired through the Internet. Alternatively, having the human avatar sign into each of the two devices with their specific user credentials would inform the system to logically pair the two devices through the Internet. Once the devices are logically paired, the human avatar 100 uses the third electronic device 220 to control the first electronic device 120 without having to directly connect the two devices.

As one skilled in the art may appreciate, there are many configurations for the head-mounted unit 110 that is worn by the human avatar 100. The invention is not limited to the designs described here.

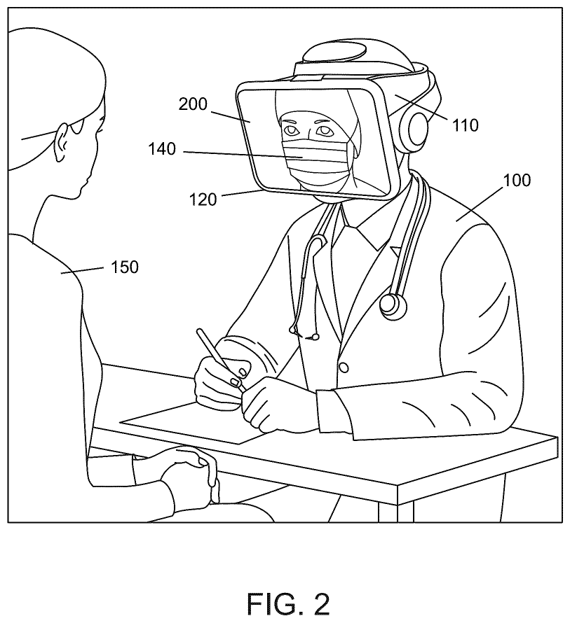

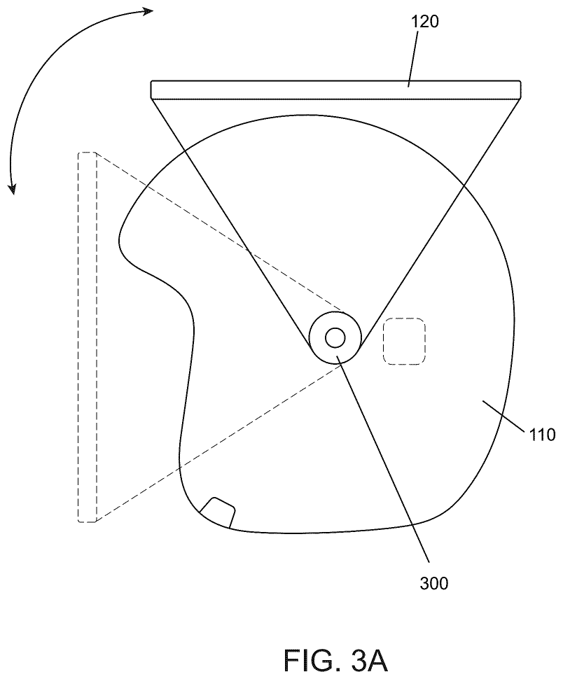

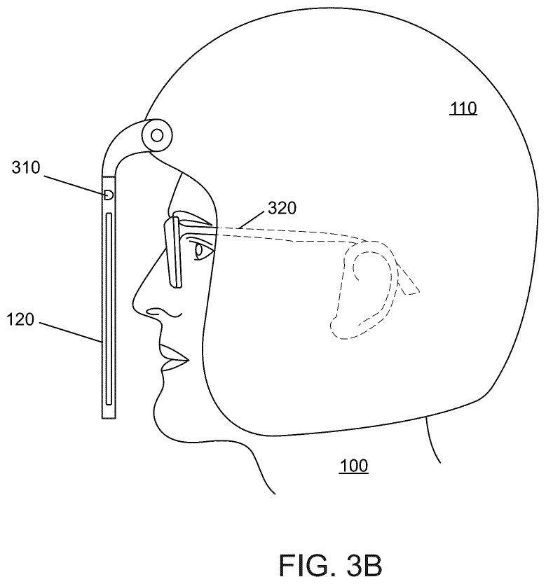

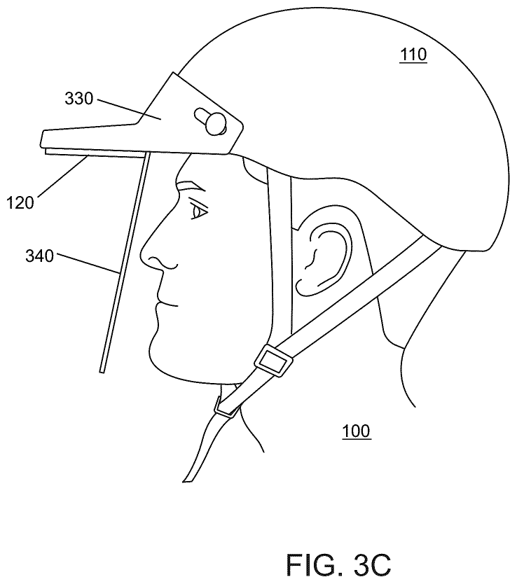

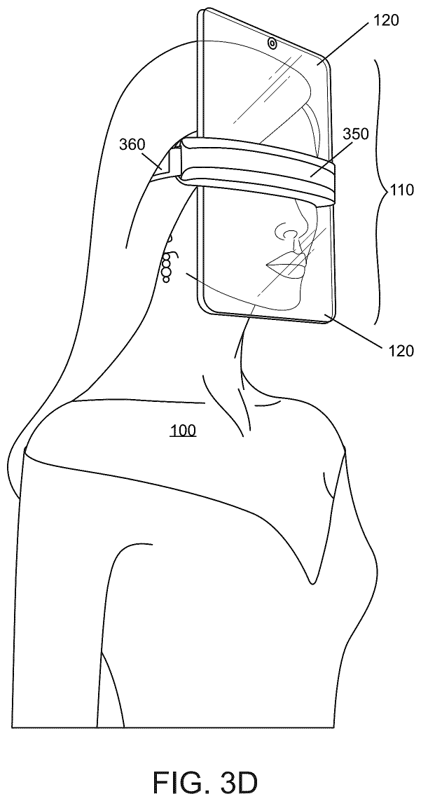

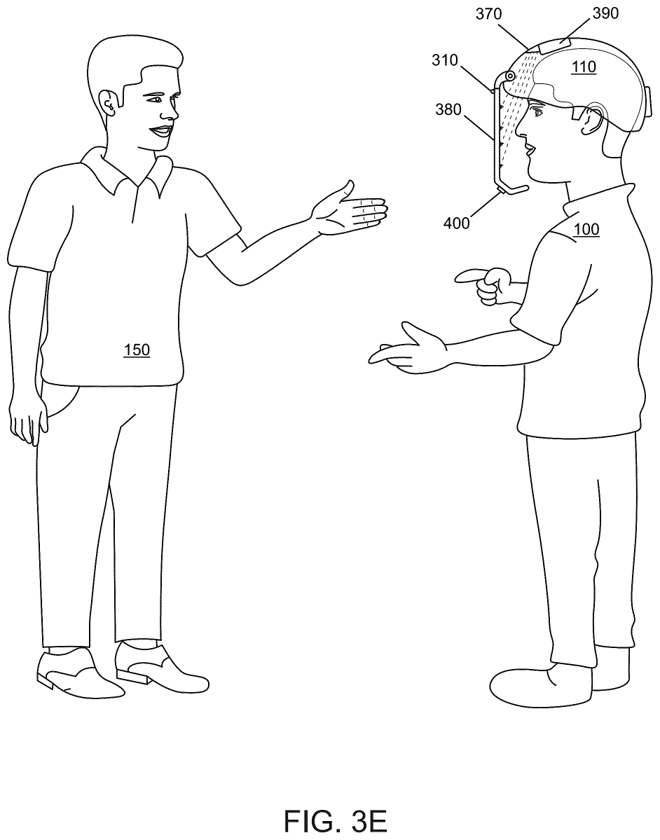

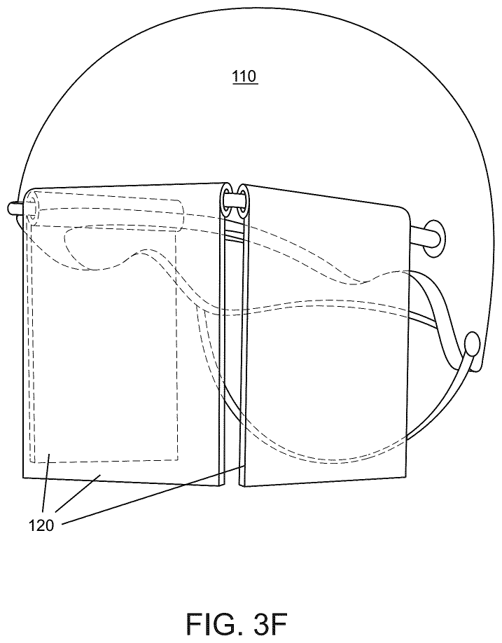

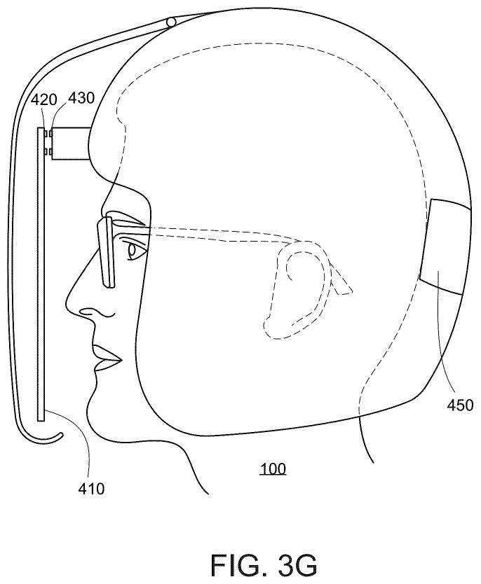

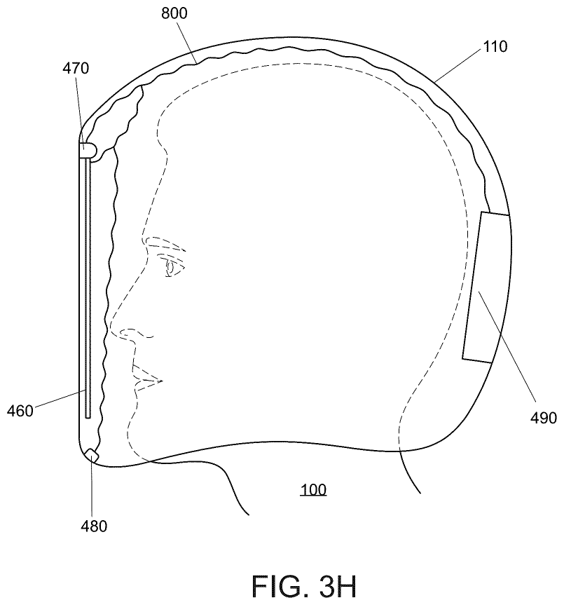

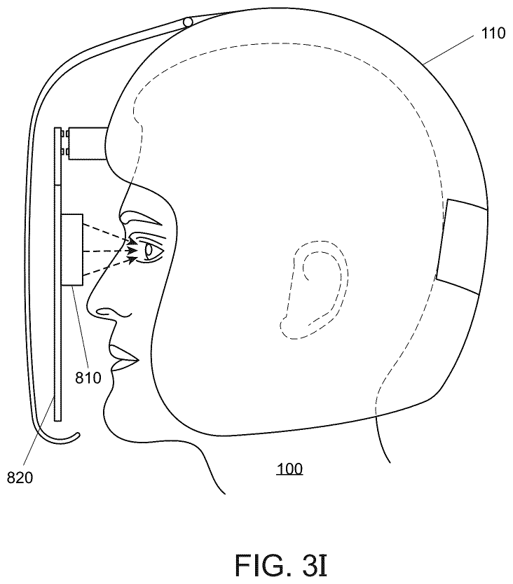

In one embodiment, illustrated by FIG. 2, the head-mounted unit 110 is an obstructed view helmet where the first electronic device 120 is mounted in a manner which substantially covers the face of the human avatar 100. In one embodiment, the first electronic device's display 200 shows a video image of the remote user 140 to the local user 150. The disadvantage of this configuration is that the human avatar 100 must rely on their vision around the periphery of the first electronic device 120. The obstructed view may not be a problem, though, when the human avatar 100 is sitting at a conference table or moving slowly around a room. Another embodiment, shown in FIG. 3G, also uses an obstructed view helmet with a display that is detachable and removable. In one embodiment, the display is an electronic tablet held in a specialized tablet case 410. The specialized tablet case 410 has a first set of magnets 420 on the rear side of said tablet case 410. The first set of magnets 420 couples with a second set of magnets 430 that are mounted to the helmet 110. In another embodiment, the helmet 110 has an attached smooth, continuous outer surface 440 and the tablet display 410 is inserted inside of the outer surface 440, between said outer surface 440 and the face of the human avatar 100. In another embodiment, the outer surface 440 is tinted to hide the tablet case 410 and the face of the human avatar 100 from view. The tablet can be removed from the helmet 110 in order to be charged or to enable the user to use the touchscreen functionality of the tablet. In another embodiment, metal counterweights 450 are embedded inside the helmet 110 so as to balance the weight of the entire apparatus by counteracting the weight of the tablet flexing the neck of the human avatar 100. The counterweights 450 move the center of gravity back toward the center of the head so that it is more comfortable for the human avatar 100.

In another embodiment, the obstructed view helmet has a visor on the front such as that found on a baseball helmet, and the visor has holes that pass all the way through the visor so that the human avatar 100 can see through the visor and in front of themselves when their head is tilted forward slightly. In another embodiment, the visor is solid but made of a darkly tinted, two-way mirrored transparent material so that the human avatar 100 can see through it when their head is tilted forward slightly, but the local user 150 cannot see through the visor to the face of the human avatar 100.

In another embodiment, the obstructed view helmet uses a helmet 110 with a metal face cage on the front such as that found on a hockey helmet. The helmet 110 is lightweight and more comfortable for the human avatar 100 when traveling by foot in which case the protection provided by a heavier helmet is not needed. The first electronic device 120 is attached to the front of the face cage so that it is easily seen by the local user 150. In another embodiment, the face cage with the attached first electronic device 120 is connected to the helmet 110 on the sides by a swivel mechanism that allows the face cage to move between a raised position above the head and a lowered position in front of the face of the human avatar 100. In another embodiment, the face cage is detachable and the helmet 110 can be worn without the face cage with the attached first electronic device 120. In another embodiment, the face cage is solid and made of a darkly tinted, two-way mirrored transparent material so that the human avatar 100 can see around the sides, top and bottom of the first electronic device 120, but the local user 150 cannot see through the face cage to the face of the human avatar 100.

In another embodiment, the head-mounted unit 110 is a military helmet with a camouflaged surface and made of a bulletproof material.

In another embodiment, the first electronic device 120 attached to the head-

mounted unit 110 shows a first video image of the remote user 140 and a second video image mirror of the local user 150 so that the local user 150 can see how they appear to the remote user 140. This second video image may be shown as a picture-in-picture image on the display of the first electronic device 120, shown on a second smaller display adjacent to the display, or in some other manner.

In another embodiment, the display of the first electronic device 120 is a curved display.

In another embodiment, illustrated by FIG. 3A, the head-mounted unit 110 is an open-faced motorcycle helmet. The motorcycle helmet 110 is used by a human avatar 100 when on a motorcycle or scooter and traveling to the location of a local user 150. The first electronic device 120 is in a raised position above the head during travel. In one embodiment, the first electronic device 120 is attached to a swivel mechanism 300 on both sides of the helmet 110. When in the raised position, the first electronic device 120 locks into the upright position by the swivel mechanism 300 where it attaches to the helmet 110. In one embodiment, a standard face shield or visor can be fitted to the helmet 110 and swivel separately to provide facial protection while traveling. When videoconferencing with the local user 150, the first electronic device 120 is in the lowered position. If the first electronic device 120 is mounted below eye level in this position, the human avatar can have a partial view in front of them as well as on the sides and bottom of the first electronic device 120. This allows the human avatar 100 to walk more confidently than if the first electronic device 120 is mounted at a level that does not allow the human avatar 100 to see forward.

In another embodiment, illustrated in FIG. 3B, the head-mounted unit 110 is an obstructed view helmet with pass-through vision where an additional feature is added to enable the human avatar 100 to see in front of themselves more clearly using pass-through vision. At least one pass-through vision camera 310 is mounted on the first electronic device 120, which captures and transmits a real-time video image to personal video viewing glasses 320 worn by the human avatar 100, allowing the human avatar 100 to have pass-through vision of the area in front of themselves. The Oculus Quest 3© and Apple Vision Pro are examples of stereoscopic pass-through vision where a plurality of cameras are mounted in the front of a head mounted display and those images are transferred to the respective eyes of the viewer. An advantage of this embodiment is that it allows the first electronic device 120 to be mounted at the same level as the face of the human avatar 100 since the human avatar 100 no longer has to see around the first electronic device 120 to know what's in front of him or her. In another embodiment, the at least one pass-through vision camera 310 is mounted on the helmet 110 and transmits a video image to the personal video viewing glasses 320 either directly or indirectly through the first electronic device 120.

In another embodiment, shown in FIG. 3C, the head-mounted unit 110 is a reflection screen helmet, where the display of the first electronic device 120 is not viewed directly by the local user 150, but rather the local user 150 sees a reflection of the display in the same way a standard teleprompter works. The first electronic device 120 is mounted on the underside of a visor 330 attached to the front of the helmet 110. A reflection screen 340 which consists of a two-way mirror, is attached to the underside of the visor 330 between the first electronic device 120 and the face of the human avatar 100, and extends downwards to the bottom of the face of the human avatar 100. The light from the display of the first electronic device 120 shines downwards and reflects off the reflection screen 340 towards the local user 150. The angle of the reflection screen 340 is adjustable via hinge, swivel mechanism or another similar mechanism, so that the reflection meets the eyeline of the local user 150. Given that the region behind the reflection screen 340 is darker than the ambient light, the local user 150 cannot easily see the face of the human avatar 100, while the human avatar 100 is able to see through the reflection screen 340 to the area in front of themselves. A disadvantage of this embodiment is that the reflection is generally not as bright as viewing the display of the first electronic device 120 directly.

In another embodiment, shown in FIG. 3D, the head-mounted unit 110 is a composite facial display helmet where multiple displays are used to show a composite image of the face of the remote user 140. At least two displays of the first electronic device 120 are used to show different parts of the face of the remote user 140. FIG. 3D shows only one example of this embodiment and many other designs are possible. In this example, two displays of the first electronic device 120 are attached above and below a narrower horizontal strip 350 of a tinted transparent surface that lines up with the eyes of the human avatar 100, through which the human avatar 100 can see. Due to the tint of the surface, the eyes of the human avatar 100 cannot easily be seen by the local user 150. On both ends, the horizontal strip 350 connects to a strap 360 that goes around the head and supports the head-mounted unit 110 in place in front of the face of the human avatar.

In another embodiment, the head-mounted unit 110 is a punched out display helmet which has one or more displays that are part of the first electronic device 120, with at least one hole punched out of the one or more displays, through which the human avatar 100 can see. In another embodiment, the software application running on the first electronic device 120 displays the video image of the remote user 140 in such a way as to align two punch-outs in the one or more displays in front of the eyes of the human avatar 100, with the eyes of the remote user 140.

In another embodiment, shown in FIG. 3E, the head-mounted unit or helmet 110 is a rear projection helmet which houses a short-throw projector 370 to display the video image of the remote user 140 on a rear-projection screen 380 extending downward from the helmet 110 in front of the face of the human avatar 100. The first electronic device 120 is composed of a controller 390 connected to the short-throw projector 370, a camera 310, a microphone 400 and speakers. The rear-projection screen 380 is transparent and has a rear-projection film applied to it. The controller 390 connects to the Internet to send and receive data to and from the second electronic device 130 and the third electronic device 220. The controller 390 sends a video image of the remote user 140 to the short-throw projector 370 which transmits light to the rear-projection screen 380 so that the local user 150 can see a projected video image of the remote user 140. The rear-projection screen 380 is tinted so that the local user 150 does not see the face of the human avatar 100. The rear-projection screen 380 may be flat or curved, and in the case that it is curved, the controller 390 makes adjustments to the video image sent to the short-throw projector 370 to account for the curvature and optimize for a natural facial appearance to be displayed on the screen 380.

In another embodiment, shown in FIG. 3F, the head-mounted unit or helmet 110 is a front-side display helmet that has at least one display of the first electronic device 120 attached to the front of the helmet 110 and at least one display of the first electronic device 120 on each side attached to the side of the helmet 110. In this embodiment, multiple camera angles of the remote user 140 can be shown on the head of the human avatar 100. These video images are constructed using a 3D face model of the remote user 140 captured by the second electronic device 130 and transmitted to the first electronic device 120. In one embodiment, the 3D face model is created using an infrared front-facing surface detector, such as that used for FaceID and well known in the art. It may also use LIDAR or similar technology to create the 3D model, however. The construction of a 3D model is well known in the art and out of the scope of this invention, but the utilization of the technology to create and render a 3D model of someone's face is part of this invention. In another embodiment, where the remote user 140 wishes to conceal their identity, they may use an alternate 3D model, or even a 3D model of a cartoon character. In another embodiment, the 3D model is stored locally on the first electronic device 120 so that it does not need to be transmitted across the Internet. In this case, only the vector coordinates are transmitted from the second electronic device 130 to the first electronic device 120 and are used by the first electronic device 120 along with the 3D face model, to produce the images to display on the one or more displays 120 attached to the head-mounted unit 110.

In another embodiment, the 3D face model is used with the rear projection helmet to generate an image of the face at the vantage point of the local user 150 and project the image accordingly onto the rear-projection screen 380. The system uses cameras mounted on the helmet to monitor the position of the eyes of the local user 150 relative to the helmet 110. This information is transmitted to the controller 390 which sends an adjusted video image to the short-throw projector 370 which transmits the image in light to the rear-projection screen 380, as shown previously in FIG. 3E.

In another embodiment, shown in FIG. 3H the helmet 110 has a transparent OLED (TOLED) screen 460 mounted on its front inside with a camera 470 mounted above said screen 460, and a microphone 480 mounted below. The transparent OLED technology allows the wearer to see through the display 460 with varying degrees of acuity based on how many gaps there are between the OLED elements. The screen 460, camera 470 and microphone 480 have a wireless connection 800 to a small electronic device 490 in the rear that houses the processor 710, memory 720, storage 730 and communications hardware 750. In another embodiment, there is also a metal counterweight 450 in the back of the helmet 110 as seen in FIG. 3G. While this embodiment shows a transparent OLED display 460, any transparent or semi-transparent display can be used provided that it does not require backlight to illuminate the display from behind. The transparent display 460 should also transmit most of the light forward toward the front exterior of the helmet, and should minimize the light illuminating backwards to protect the human avatar 100. To accomplish this, in another embodiment there is an extra coating on the rear of each OLED, which could include an anti-reflective coating. In another embodiment, the OLED display 460 refresh rate is synchronized with an LCD panel behind it so that light from the OLED is blocked by the opaque LCD state at times when the OLED is emitting light, and the LCD panel is transparent at times when the OLED is not transmitting light. In another embodiment, an alternative or additional way to protect the eyes of the human avatar 100 is to use a polarized transparent OLED display, and have a polarization filter behind the transparent OLED display so that light from the OLED display is substantially filtered, whereas the portion of light that is of opposite polarity from the exterior of the helmet will pass through the filter to the eyes of the human avatar 100.

In another embodiment, the transparent screen is a transparent microLED screen or any other transparent screen technology.

In another embodiment shown in FIG. 3I, a rear-facing display 810 is incorporated into the main display 820 in front of the face of the human avatar 100 wearing the helmet 110. It is positioned in front of one of the eyes of the human avatar 100 and still allows the human avatar 100 to use that eye to view the periphery around the screen. When the human avatar 100 looks forward they can see the image in the rear-facing display 810. This can be used to display a low-resolution, uncropped feed from the second electronic device (130; FIG. 1) that shows the upper body of the remote user (140; FIG. 1) whose face is shown on the main display 820. This allows the human avatar 100 to see hand gestures of the remote user 140, so that the human avatar 100 can then act out said hand gestures in-person in front of the local user 150. To enable this, the software application on the second electronic device 130 sends a raw, low resolution feed for display on the rear-facing display 810, as well as the higher resolution feed of the cropped face to display on the main display 820.

Any person may act as a remote user and contract directly with a human avatar using the invention detailed thus far. The invention further includes a network marketplace of human avatars that are available to serve remote users on-demand. It is best described by way of the figures and descriptions that follow.

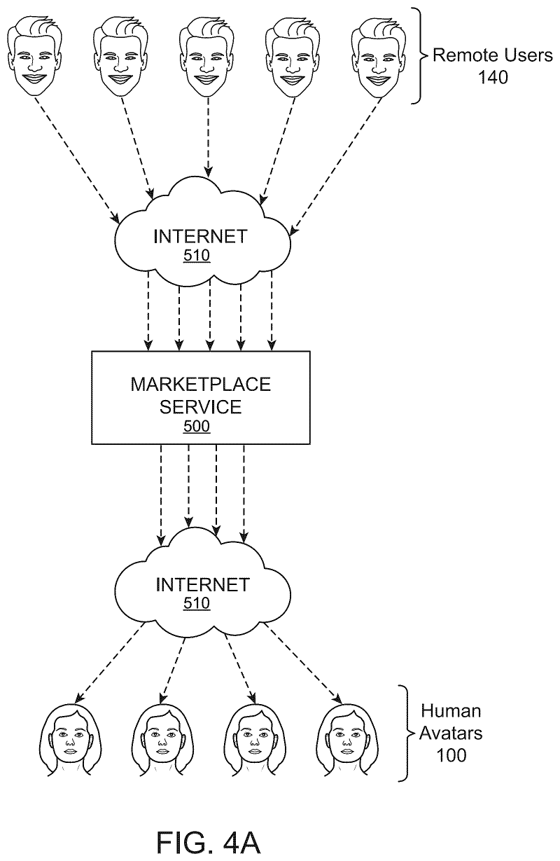

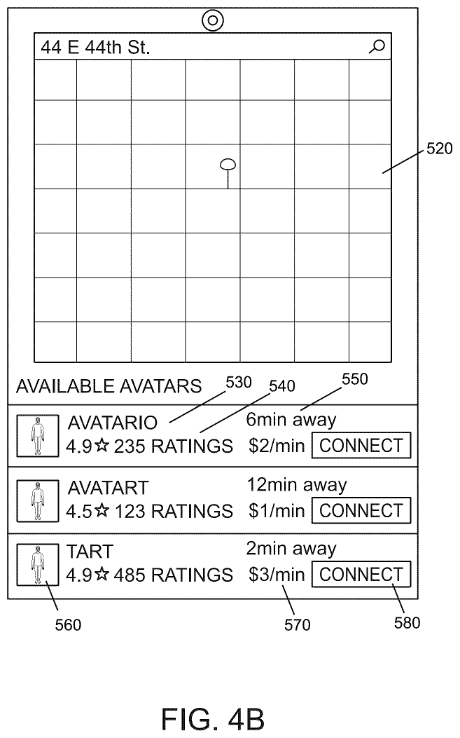

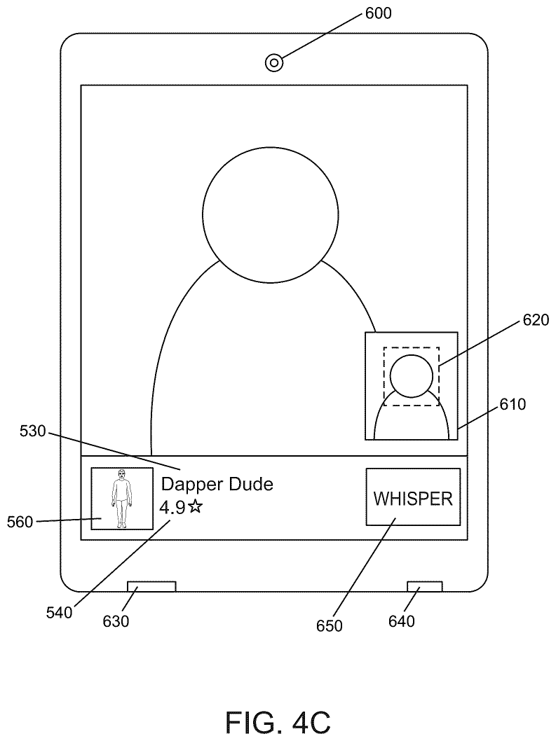

FIG. 4A shows a network diagram with a marketplace service 500 in the center, which may be a web server with attached data storage. It is connected to the Internet 510. Remote users 140 connect with the marketplace service 500 using a mobile application. Human avatars 100 are configured to connect to the service using a mobile application. This type of marketplace is similar to that of a ride-sharing company like Uber©. The locations of the human avatars 100 are detected by GPS capabilities of their mobile devices and shared with the marketplace service 500.

FIG. 4B shows the screen of a remote user's mobile phone, and specifically the mobile application of the marketplace service 500. The remote user 140 searches for the address at which they would like to be telepresent, in this case 44 E 44th St. The location is shown on the map 520, and available human avatars are listed below. In this example, three avatars are shown as available and each has an alias 530, average star rating 540 (from the feedback of other remote users 140), a time indication 550 of how far away they are (accounting for their specific mode of transportation, whether it be by car, motorcycle, or by foot). There is a photo 560 of each human avatar 100 that shows the body that the face of the remote user 140 will be on. Human avatars 100 may command different rates and the price 570 for each is shown. The remote user 140 can tap the “CONNECT” button 580 to connect with a human avatar 100 and hire them for the assignment. The human avatar 100 would then travel to the desired location specified by the remote user 140, and the telepresence would be initiated by the human avatar 100.

FIG. 4C shows the remote user's mobile phone when the telepresence is active. There is a camera 600 recording their face and this is shown on the screen as the remote user display 610 in a small rectangle on the lower right side of the image. There is a head position guide 620 which is an indication in the remote user display 610 where the remote user 140 should position their head in relation to the camera. If they are too close, they will get a “Move further away” message on the screen, and if they are too far they will get a “Move closer” message on the screen. The mobile application may have an image processing pipeline providing image stabilization (so that the pupils are always in the same position) and rotates and crops the head of the remote user 140 in the image so that only the face is transmitted to the display on the human avatar of FIG. 4B. The image processing pipeline may also perform gaze correction, so that it looks like the person in the image is looking directly at the camera. Gaze correction algorithms are well known in the art. The remote user 140 can also see the human avatar name or alias 530, the human avatar photo 560, and star rating 540. The remote user 140 can see the local user 150 on the screen and converse with them using the microphone 630 and speaker 640. The remote user 140 can press down the whisper button 650 then whatever they say is transmitted not to the local user 150, but instead to the human avatar 100. Examples of commands the remote user 140 could give to the human avatar 100 might be “shake his hand” or “give a high five”.

The display on the human avatar's electronic device using the mobile app is described here in the embodiment where the human avatar 100 is using a third electronic device 220 in the system in conjunction with the first electronic device 120 attached to the head-mounted unit 110. The human avatar 100 is looking down at the display of the third electronic device 220 in their hand from underneath the head-mounted unit 110. The display shows the local user 150, which can also be helpful in allowing them to maneuver in their surroundings given that the first electronic device 120 may be obstructing their vision. The display also shows the face of the remote user 140, which is cropped and is the same image that is shown to the local user 150. The remote user's photo is displayed along with their name and rating. If the human avatar 100 holds down the whisper button on the display, they are able to speak directly to the remote user 140. The microphone to capture this speech may be located on the earpiece worn by the human avatar 100, built into the helmet 110 specifically for the voice of the human avatar 100, or it may be the same microphone that is being used to capture the speech of the local user 150.

In another embodiment, when the human avatar 100 needs to gain access to a physical space, identity credentials may be shared from the remote user 140 using the second electronic device 130 to the third electronic device 220 used by the human avatar 100. The credentials may be a visual pass, a code that is scanned, or an NFC credential. In another embodiment, when payments need to be made (for example, shopping in a store), the payment credentials of the remote user 140 can be generated and shared with the human avatar 100 in a secure way, using a virtual credit card number, or via an NFC credential, thereby providing the means for a remote user 140 to make a local payment mediated by the human avatar 100.

The invention has detailed extensively how a system using telepresence and a human avatar 100 can most realistically reproduce, for a local user 150, a face-to-face conversation with a remote user 140. Much work has been done over the past few decades to improve virtual reality (VR), and the hardware and software that is used to make someone feel like they are immersed in a virtual or real environment. In another embodiment, a VR headset can be used by the remote user 140 with this telepresence system to enable a greater degree of immersion into the environment of the local user 150. When the remote user 140 is wearing a VR headset, a different method of rendering the face of the remote user 140 with a 3D model is required. The facial movements of the remote user 140 can be detected by cameras on the inside and outside of the VR headset. The Apple® Vision Pro can be used by the remote user 140 in this invention to implement this type of scanning of a user's face to create a realistic avatar using a 3D model, which can then be shown on the first electronic device 120 to the local user 150.

In another embodiment, a desired head position can be relayed from the remote user 140 to the human avatar 100. It may be useful for a remote user 140 to be able to look to the left, right, up or down, and have the human avatar 100 do this as well. This process starts by capturing the input of the desired head orientation of the human avatar 100 from the remote user 140. The remote user 140 is using a second electronic device 130 equipped with motion hardware (790; FIG. 5), such as gyroscopes, accelerometers, and even the backward-facing camera, to determine how the device is being moved through space. Those movements are then relayed to the human avatar 100 when the human avatar 100 is wearing personal video viewing glasses 320. A target symbol is overlaid on the image coming from the front-facing camera that instructs the human avatar 100 to move their head to align the center of view with the target symbol. To enable this, there may be another symbol which shows the center of view and when those two symbols are on top of each other, the human avatar 100 knows they are looking in the right direction. In another embodiment, if the remote user 140 is using a VR headset as the second electronic device 130, then the accelerometers, gyroscopes and front-facing cameras of the headset are used to determine the head orientation of the remote user 140 and that information is transmitted to the human avatar 100 to instruct them of the desired head orientation.

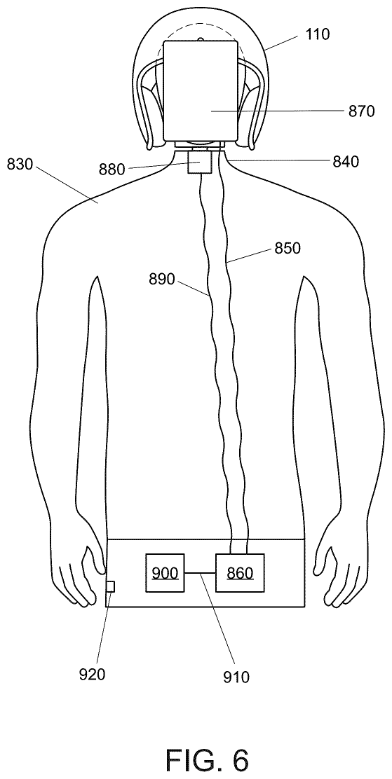

In another embodiment, illustrated in FIG. 6, the head-mounted unit 110 can be placed or docked on a robotic upper body 830 to relieve the human avatar 100 when the human avatar 100 would otherwise need to sit in a stationary position wearing the helmet 110 for extended periods of time. The helmet 110 in this case essentially serves as the robotic head of a robotic upper body 830, but can also still be worn on the head of the human avatar 100. The robotic upper body 830 has a neck 840 which can pan left and right and respond to the aforementioned signals from the second electronic device 130. In another embodiment, the robotic upper body 830 is a dressable mannequin body that can be styled appropriately to match the remote user 140 using the second device 130. In another embodiment, a USB cable 850 from the robotic upper body controller 860 is inserted into the tablet 870 in the helmet 110, providing both power and also receiving position commands from the tablet 870. In another embodiment the controller 860 and the tablet 870 are connected wirelessly to transmit data to and from each other, using a technology such as Bluetooth® or others. The software application running on the tablet 870 receives the positional information from the second device 130 and translates it into commands for a stepper motor 880 in the neck 840 of the robotic upper body. The stepper motor 880 is connected by a first cable 890 to the controller 860. The stepper motor 880 moves the “head” of the robotic upper body 830 which is essentially comprised of the helmet 110 and tablet display 870. The functions of the robotic upper body 830 described above are powered by a battery 900 integrated into the robotic upper body 830. The battery 900 is connected by a second cable 910 to the controller 860. The battery 900 is charged through a DC power supply 920, which is also integrated into the robotic upper body 830.

In another embodiment, the resolution of the face on the helmet display can be improved by using an image processing library, such as OpenCV, to determine the position of landmarks on the face of the remote user 140, and having the second electronic device 130 send the position landmark data to the first electronic device 120 instead of a live video feed. The position landmark data can then be reconstructed into a face image on the first electronic device 120. In order for this to work, a high resolution surface image of the face of the remote user 140 is transmitted, ahead of time or at the start of the call, along with a 3D model of the face of the remote user 140, to the first electronic device 120. Since local users 150 interacting with the avatar may find the reconstructed image to be too artificial and less trustworthy, this technique can be blended with a live video feed, as well known in the art. In another embodiment, video upscaling can be used on the first electronic device 120, which may be facilitated by an artificial intelligence model. This feature is facilitated by using a first electronic device 120 with sufficient processing power to enable the video upscaling in real time.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention.

For example, in an alternative embodiment, the telepresence system integrates an artificial intelligence (AI) agent as the remote caller, replacing a human participant. The helmet, equipped with a display, can render a dynamically generated face or avatar representing the AI agent. This rendered face may either be processed locally on the helmet or generated on a central server and streamed to the helmet in real time. The AI agent, represented by the rendered face, provides a lifelike presence capable of real-time expression and lip-syncing to maintain a human-like interaction. The person near the local user can engage with the AI agent through the helmet, leveraging natural language processing capabilities for conversational exchanges. This embodiment enables flexible deployment of computational resources while extending the functionality of the system to scenarios where a human caller is unavailable or unnecessary, providing seamless, interactive experiences through a robust digital interface.

It should further be noted that throughout the entire disclosure, the labels such as left, right, front, back, top, bottom, forward, reverse, clockwise, counterclockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, references to “first,” “second,” “third,” and etc. members throughout the disclosure (and in particular, claims) are not used to show a serial or numerical limitation but instead are used to distinguish or identify the various members of the group.

What is claimed is:

1. A system enabling the telepresence of a remote user on a human avatar, comprising:
a head-mounted unit configured to be worn by the human avatar.

2. The system of claim 1, further comprising a first electronic device equipped with at least one display, at least one microphone, at least one speaker, at least one camera, a processor, memory, a data storage, and hardware configured to enable the first electronic device to communicate with a second electronic device, wherein the first electronic device is attached to, or integrated into, the head-mounted unit and is configured to be positioned in front of the human avatar's face;
a second electronic device configured to be operated by the remote user, wherein the second electronic device comprises at least one display, at least one microphone, at least one speaker, at least one camera, a processor, memory, a data storage, and hardware configured to enable the first electronic device to connect to the Internet;
a software application executed on the first electronic device and the second electronic device, wherein the software application is configured to enable the second electronic device to transmit data containing a live video-audio feed, via the Internet or a cellular network, to the first electronic device and vice-versa.

3. The system of claim 2, further comprising a third electronic device operated by the human avatar, wherein the third electronic device comprises at least one display, at least one microphone, at least one speaker, at least one camera, a processor, memory, a data storage, hardware configured to enable the third electronic device to connect to the Internet and cellular network, and hardware configured to enable the third electronic device to communicate with the first electronic device via short range wireless communication; and, wherein the software application is executed on the third electronic device enabling the human avatar to control the first electronic device, and transmit data, via the Internet or the cellular network, between the second electronic device used by the remote user, and the third electronic device used by the human avatar, enabling the human avatar and the remote user to communicate with each other by audio or text.

4. The system from claim 3, wherein the software application executed on the second electronic device configured to be used by the remote user includes a “whisper” element enabling the remote user to speak into the microphone to transmit a first audio message to only the third electronic device, wherein the human avatar is configured to receive the first audio message through earphones worn by the human avatar; and, wherein the software application executed on the third electronic device configured to be operated by the human avatar also includes a “whisper” element enabling the human avatar to speak into the microphone of the third electronic device to transmit a second audio message to the second electronic device operated by the remote user and played back to the remote user through speakers or headphones worn by the remote user or displayed as text on the display.

5. The system of claim 3, wherein the software application executed on the second electronic device configured to be used by the remote user includes a “whisper” element enabling the remote user to send a first text message, by speaking into the microphone or typing, to only the third electronic device, wherein the human avatar is configured to receive the first text message on the third electronic device; and, wherein the software application executed on the third electronic device configured to be operated by the human avatar also includes a “whisper” element enabling the human avatar to send a second text message, by speaking into the microphone or typing, back to the second electronic device operated by the remote user and played back to the remote user through speakers or headphones worn by the remote user or displayed as text on the display.

6. The system of claim 3, wherein the first electronic device attached to, or integrated into, the head-mounted unit and the third electronic device configured to be used by the human avatar are logically paired to communicate with each other by the third electronic device scanning a QR code on the first electronic device or by the human avatar signing into each device with their specific system user credentials.

7. The system of claim 2, wherein the head-mounted unit is a vehicle helmet which protects the human avatar during transit, and the first electronic device attached to, or integrated into, the head-mounted unit is connected to a swivel mechanism mounted on both sides of the head- mounted unit, enabling the first electronic device to move between a first position in front of the human avatar's face and a second position above the human avatar's head.

8. The system of claim 2, wherein a portion of the head-mounted unit is made of a darkly-tinted, two-way transparent mirrored material through which the human avatar can see and the local user cannot.

9. The system of claim 2, wherein the first electronic device attached to, or integrated into, the head-mounted unit displays video of the remote user and video of the local user simultaneously on the at least one display.

10. The system of claim 2, wherein the at least one display of the first electronic device is a curved screen.

11. The system of claim 2, wherein there is at least one camera on the head-mounted unit or first electronic device, that transmits data in the form of video to personal video viewing glasses worn by the human avatar to enable the human avatar to have pass-through vision to view their surroundings.

12. The system from claim 2, wherein the at least one display of the first electronic device is attached to, or integrated into, a bottom portion of a front visor on the head-mounted unit and oriented to face downwards, and the video image on the at least one display reflects off of a two- way mirror attached to the head-mounted unit and extending downwards in front of the human avatar's face and oriented at an angle to reflect the video image into an eyeline of the local user.

13. The system of claim 2, wherein the first electronic device attached to, or integrated into, the head-mounted unit has two displays, a first display above and a second display below a horizontally-oriented two-way mirror strip through which the human avatar can see in front of themselves without their eyes being seen by the local user.

14. The system of claim 2, wherein the at least one display of the first electronic device is a plurality of displays, with each display positioned on a different location on the head-mounted unit, and the second electronic device configured to be used by the remote user is configured to produce a 3D face model of the remote user and transmit data containing the 3D face model to the first electronic device, and the software application executed on the first electronic device is configured to use the 3D face model to display portions of the remote user's face on the plurality of displays of the first electronic device to provide a realistic 3D video image of the remote user's face to the local user.

15. The system of claim 2, wherein the at least one display of the first electronic device is a shape with a rear-projection film applied, wherein the at least one display is attached to, or integrated into, the head-mounted unit and positioned in front of the human avatar's face, and the second electronic device configured to create a 3D face model of the remote user and transmit data containing the 3D face model to the first electronic device, and the first electronic device configured to transmit data to a short-throw projector positioned inside the head-mounted unit, and the short-throw projector configured to transmit light to the at least one display to display a video image of the remote user on the at least one display for viewing by the local user, and the first electronic device configured to use the 3D face model to make adjustments of the video image based on the shape of the at least one display to provide an accurate appearance of the remote user's face to the local user, and wherein the at least one display is tinted such that the local user is not able to see the face of the human avatar.

16. The system of claim 15, wherein one or more cameras are mounted on the head-mounted unit or the first electronic device and are configured to monitor and transmit the position of the local user's eyes to the first electronic device, wherein the first electronic device using the 3D face model renders an accurate video image of the remote user's face at a vantage point of the local user and produces the video image on the at least one display using the short-throw projector to create the video image on the at least one display with the rear-projection film applied.

17. The system of claim 16, wherein the 3D face model is an alternate 3D face model of a face different than that of the remote user, including another human face or a cartoon face.

18. The system of claim 17, wherein the 3D face model is stored locally on the memory of the first electronic device and vector coordinates of facial movements of the remote user are captured by the second electronic device and transmitted to the first electronic device and are used by the first electronic device with the locally stored 3D face model to modify the video image of the remote user to be displayed to the local user.

19. The system of claim 2, wherein the display of the first electronic device is a transparent electronic screen capable of displaying a video image of a remote user using a technology such as but not limited to transparent OLED and transparent microLED.

20. The system of claim 2, wherein the head-mounted unit with the attached or integrated first electronic device is configured to be docked on a robotic upper body and serve as the robotic head of the robotic upper body, and the head-mounted unit able to connect to an electronic controller integrated into the robotic upper body for the transmission of data as well as power to charge the head-mounted unit, and the robotic upper body having a stepper motor which receives data and power from said electronic controller, and said stepper motor able to move the robotic head of the robotic upper body according to data received from the electronic controller based on data received from the head-mounted unit.

21. A system enabling a digital marketplace for human avatars, comprising:
a web server with attached data storage, connected to the internet;
a mobile application configured to connect a human avatar and a remote user to the web server through a mobile electronic device;
the mobile application able to detect the location of the human avatar through the GPS capability of the mobile electronic device of the human avatar;
the mobile application able to display the location of the human avatar to other users on the mobile application;
the mobile application further able to display a rating, a photo, a price and an alias for the human avatar, as well as a travel time for the human avatar to reach the current location of the remote user wishing to hire a human avatar;
the mobile application enabling the remote user to book the human avatar for an assignment; and
the mobile application enabling the remote user to join a videoconference with a local user, and the videoconference being facilitated by a head-mounted unit configured to be worn by the human avatar.
